(19) United States
(12) Patent Application Publication
(10) Pub. No.: US 2022/0104678 A1
(43) Pub. Date: Apr. 7, 2022

(54) Tile scraper structure

(71) Applicant: YU-CHEN TSAI, Taichung City (TW)

(72) Inventor: YU-CHEN TSAI, Taichung City (TW)

(21) Appl. No.: 17/061,537

(22) Filed: Oct. 1, 2020

(51) Int. Cl. A47L 13/08; B25G 3/12; A47L 13/022

(52) U.S. Cl. CPC A47L 13/08; A47L 13/022; B25G 3/12

(57) ABSTRACT

A tile scraper structure contains: a handle and a blade module. The handle includes a grip portion, a connection segment, an accommodation cavity, a slidable switch having a pull lever, and a positioning element which has a fixing loop and a protrusion. The connection segment has a polygonal orifice and a slot. The blade module includes a blade and a locating seat accommodated in the polygonal orifice. The locating seat has a notch configured to engage with the protrusion. The handle further includes a spring received in the accommodation cavity and abutting against the slidable switch, such that the slidable switch actuates the positioning element so that the spring urges the protrusion to engage with the notch.

### FIELD OF THE INVENTION

The present invention relates to a tile scraper structure which is applied to scrap or remove stains or cement wastes from tiles.

### BACKGROUND OF THE INVENTION

A conventional tile scraper is applied to scrap or remove stains or cement wastes from tiles. However, a scrap blade becomes blunt after a period of using time. In addition, it is troublesome to remove and screw multiple screws when replacing the new scrap blade.

The present invention has arisen to mitigate and/or obviate the afore-described disadvantages.

### SUMMARY OF THE INVENTION

The primary aspect of the present invention is to provide a tile scraper structure which is capable of replacing scrap blades quickly.

To obtain the above mentioned aspect, a tile scraper structure provided by the present invention contains: a handle and a blade module.

The handle includes a grip portion, a connection segment, an accommodation cavity defined inside the handle adjacent to the connection segment, a slidable switch fixed on a peripheral side of the handle and having a pull lever received in the accommodation cavity, and a positioning element rotatably connected in the accommodation cavity and having a fixing loop which extends from a first side of the positioning element. The positioning element further has a protrusion which extends from a second side of the positioning element, and the connection segment has a polygonal orifice formed on a first side thereof, and the connection segment has a slot communicating with the polygonal orifice.

The blade module includes a blade and a locating seat accommodated in the polygonal orifice, and the locating seat has a notch configured to engage with the protrusion.

The handle further includes a spring received in the accommodation cavity and abutting against the slidable switch, such that the slidable switch actuates the positioning element so that the spring urges the protrusion to engage with the notch.

### BRIEF DESCRIPTION OF THE DRAWINGS

FIG. 1 is a perspective view showing the assembly of a tile scraper structure according to a preferred embodiment of the present invention.

FIG. 2 is a perspective view showing the exploded components of the tile scraper structure according to the preferred embodiment of the present invention.

FIG. 3 is a cross view showing the operation of the tile scraper structure according to the preferred embodiment of the present invention.

FIG. 4 is another cross sectional view showing the operation of the tile scraper structure according to the preferred embodiment of the present invention.

FIG. 5 is also another cross sectional view showing the operation of the tile scraper structure according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

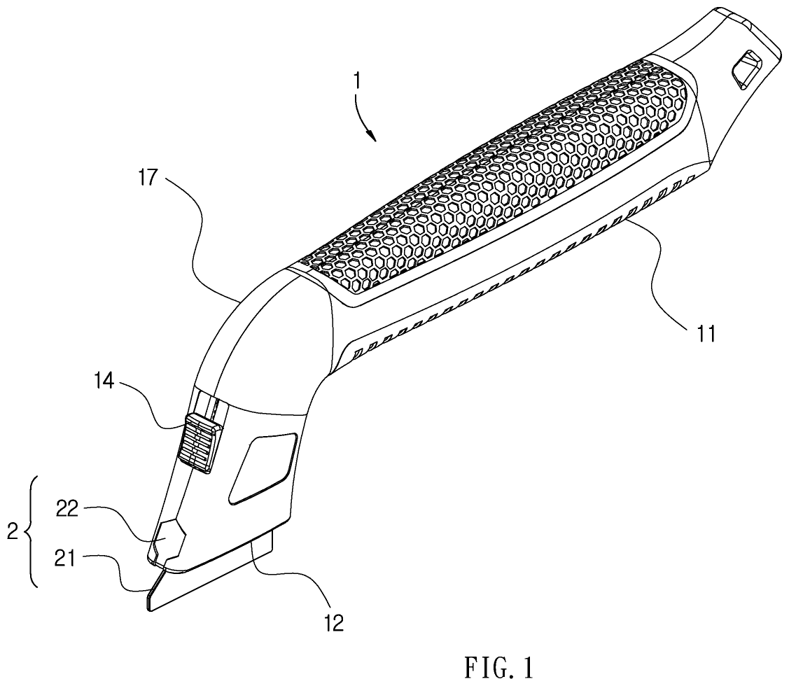

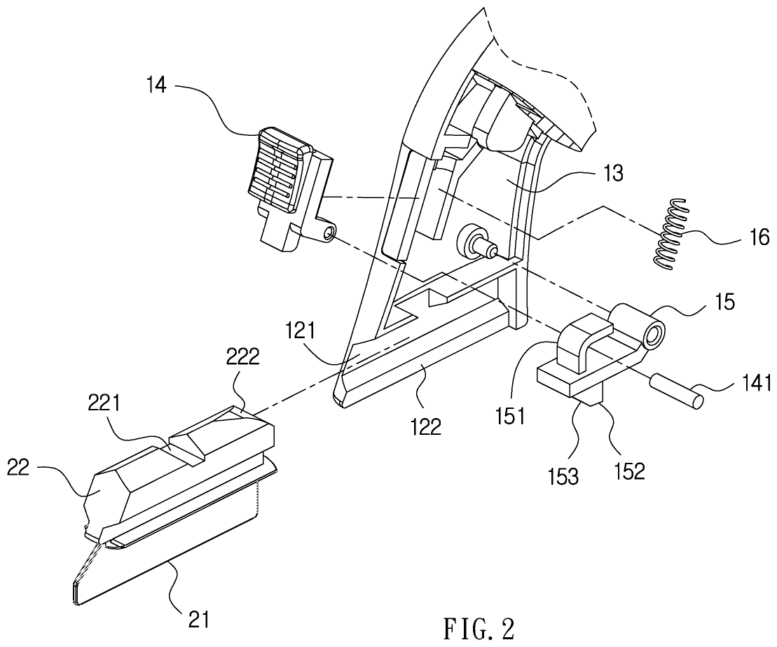

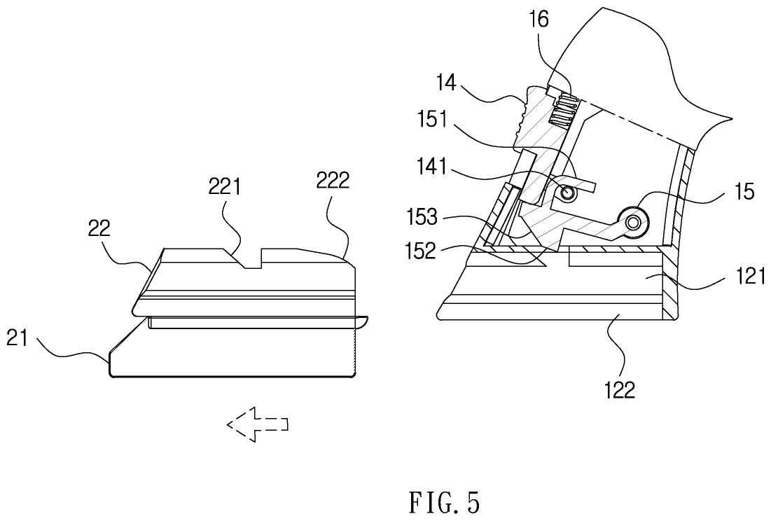

With reference to FIGS. 1 to 5, a tile scraper structure according to a preferred embodiment of the present invention comprises: a handle 1 and a blade module 2.

The handle 1 includes a grip portion 11, a connection segment 12, an accommodation cavity 13 defined inside the handle 1 adjacent to the connection segment 12, a slidable switch 14 fixed on a peripheral side of the handle 1 and having a pull lever 141 received in the accommodation cavity 13, and a positioning element 15 rotatably connected in the accommodation cavity 13 and having a fixing loop 151 which extends from a first side of the positioning element 15, the positioning element 15 further having a protrusion 152 which extends from a second side of the positioning element 15, wherein the connection segment 12 has a polygonal orifice 121 formed on a first side thereof, and the connection segment 12 has a slot 122 communicating with the polygonal orifice 121.

The blade module 2 includes a blade 21 and a locating seat 22 accommodated in the polygonal orifice 121, the locating seat 22 has a notch 221 configured to engage with the protrusion 152, such that the blade 21 extends out of the slot 122. The handle 1 further includes a spring 16 received in the accommodation cavity 13 and abutting against the slidable switch 14, such that the slidable switch 14 actuates the positioning element 15 so that the spring 16 urges the protrusion 152 to engage with the notch 221.

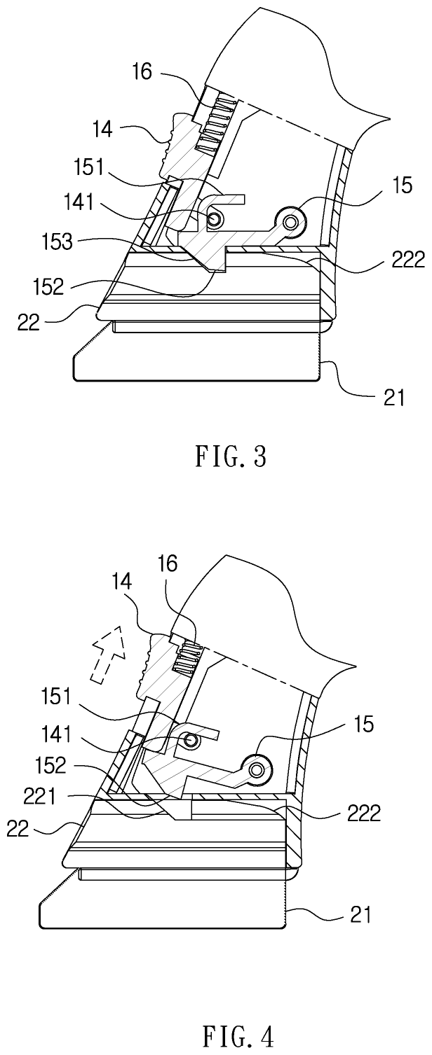

When replacing the blade module 2, the slidable switch 14 is pushed to force the spring 16 and to pull the positioning element 15 to swing by using the pull lever 141, and the protrusion 152 is removed from the notch 221 (as shown in FIG. 3) so that the locating seat 22 is detachable from the polygonal orifice 121, and another locating seat 22 of a new blade module 2 is received in the polygonal orifice 121. Thereafter, the slidable switch 14 is released so that the spring 16 moves back to an original position, and the protrusion 152 moves back to engage in the notch 221 of the locating seat 22, thus replacing the blade module 2 quickly.

The locating seat 22 has a first guide portion 222 formed on an end thereof, and the protrusion 152 has a second guide portion 153 corresponding to the first guide portion 222, such that when fixing the new blade module 2 in the connection segment 12, the locating seat 22 of the new blade module 2 is inserted into the polygonal orifice 121 by abutting the first guide portion 222 against the second guide portion 153, and the positioning element 15 is forced to swing so that the protrusion 152 is pushed by the spring 16 to engage with the notch 221.

The handle 1 further includes a bend portion 17 formed between the grip portion 11 and the connection segment 12, thus facilitating easy operation of the tile scraper structure.

Thereby, the tile scraper structure of the present invention is applied to scrap or remove stains or cement wastes from tiles. Preferably, the tile scraper structure is capable of replacing scrap blades quickly.

While various embodiments in accordance with the present invention have been shown and described, it is clear to those skilled in the art that further embodiments may be made without departing from the scope of the present invention.

What is claimed is:

1. A tile scraper structure comprising: a handle and a blade module;
wherein the handle includes a grip portion, a connection segment, an accommodation cavity defined inside the handle adjacent to the connection segment, a slidable switch fixed on a peripheral side of the handle and having a pull lever received in the accommodation cavity, and a positioning element rotatably connected in the accommodation cavity and having a fixing loop which extends from a first side of the positioning element, the positioning element further having a protrusion which extends from a second side of the positioning element, wherein the connection segment has a polygonal orifice formed on a first side thereof, and the connection segment has a slot communicating with the polygonal orifice;
wherein the blade module includes a blade and a locating seat accommodated in the polygonal orifice, the locating seat has a notch configured to engage with the protrusion; and
wherein the handle further includes a spring received in the accommodation cavity and abutting against the slidable switch, such that the slidable switch actuates the positioning element so that the spring urges the protrusion to engage with the notch.

2. The tile scraper structure as claimed in claim 1, wherein the locating seat has a first guide portion formed on an end thereof, and the protrusion has a second guide portion corresponding to the first guide portion.

3. The tile scraper structure as claimed in claim 1, wherein the handle further includes a bend portion formed between the grip portion and the connection segment.
